(19) United States
(12) Patent Application Publication
(10) Pub. No.: US 2022/0334277 A1
(43) Pub. Date: Oct. 20, 2022

(54) Superterranean Acoustic Networks, Methods of Forming Superterranean Acoustic Networks, and Methods of Operating Said Networks

(71) Applicant: ExxonMobil Upstream Research Company, Spring, TX (US)

(72) Inventors: Yibing Zhang, Annandale, NJ (US); Limin Song, West Windsor, NJ (US); Adam J. Rinehart, Spring, TX (US); Mark M. Disko, Glen Gardner, NJ (US); Xiaohua Yi, The Woodlands, TX (US); Brian C. Seabrook, Houston, TX (US)

(21) Appl. No.: 17/650,428

(22) Filed: Feb. 9, 2022

Related U.S. Application Data
(60) Provisional application No. 63/177,057, filed on Apr. 20, 2021.

(51) Int. Cl. G01V 1/00; G01V 99/00; G01V 1/50; G01V 1/28

(52) U.S. Cl. CPC G01V 1/001; G01V 99/005; G01V 1/50; G01V 1/282

(57) ABSTRACT

Superterranean acoustic networks, methods of forming superterranean acoustic networks, and methods of operating superterranean acoustic networks are disclosed herein. The superterranean acoustic networks include superterranean hydrocarbon infrastructure that extends above a ground surface, defines a waveguide, and contains a fluid. The infrastructure also includes a plurality of acoustic communication nodes spaced-apart along the superterranean hydrocarbon infrastructure. Each acoustic communication node of the plurality of acoustic communication nodes includes an acoustic transmitter and an acoustic receiver. The acoustic transmitter is configured to generate a generated acoustic signal and to supply the generated acoustic signal to the waveguide. Responsive to receipt of the generated acoustic signal, the waveguide is configured to propagate a propagated acoustic signal there through. The acoustic receiver is configured to receive another propagated acoustic signal, which is generated by another acoustic communication node of the plurality of acoustic communication nodes, from the waveguide as a received acoustic signal.

### CROSS REFERENCE TO RELATED APPLICATIONS

This application claims the benefit of U.S. Provisional Application No. 63/177,057, filed Apr. 20, 2021, and is herein incorporated by reference in its entirety.

### FIELD OF THE INVENTION

The present disclosure relates generally to superterranean acoustic networks, to methods of forming superterranean acoustic networks, and/or to methods of operating superterranean acoustic networks.

### BACKGROUND OF THE INVENTION

It may be beneficial to transmit data along an elongate tubular body, such as a pipeline and/or a drill pipe, without utilizing wires and/or radio frequency (electromagnetic) communication devices. As an example, maintaining infrastructure health may be critical for effective operations of petrochemical processes. Monitoring the integrity and conditions of infrastructure presents unique challenges due to their remote locations and large sizes, e.g. subsea tanks, long distance transport pipelines, etc. Examples abound where the installation of wires is technically difficult and/or economically impractical. The use of radio transmission also may be impractical, or unavailable, such as in cases where radio-activated blasting is occurring and/or where the attenuation of radio waves near the elongate tubular body is significant.

There are commercially available tools for integrity monitoring; however, those tools are limited for certain structures. As an example, pigging tools for pipeline inspections cannot be used for the pipelines with small sizes and/or sharp bindings. As another example, radio frequency wireless sensor/communication systems are limited to free space environment or short distances for subsea applications. As yet another example, optical fiber sensors are difficult to retrofit within existing infrastructure. Thus, there exists a need for improved superterranean acoustic networks, for methods of forming superterranean acoustic networks, and/or for methods of operating superterranean acoustic networks.

### SUMMARY OF THE INVENTION

Superterranean acoustic networks, methods of forming superterranean acoustic networks, and methods of operating superterranean acoustic networks are disclosed herein. The superterranean acoustic networks include superterranean hydrocarbon infrastructure that extends above a ground surface, defines a waveguide, and contains a fluid. The infrastructure also includes a plurality of acoustic communication nodes spaced-apart along the superterranean hydrocarbon infrastructure. Each acoustic communication node of the plurality of acoustic communication nodes includes an acoustic transmitter and an acoustic receiver. The acoustic transmitter is configured to generate a generated acoustic signal and to supply the generated acoustic signal to the waveguide. Responsive to receipt of the generated acoustic signal, the waveguide is configured to propagate a propagated acoustic signal there through. The acoustic receiver is configured to receive another propagated acoustic signal, which is generated by another acoustic communication node of the plurality of acoustic communication nodes, from the waveguide as a received acoustic signal.

The methods of forming include installing the plurality of acoustic communication nodes on the superterranean hydrocarbon infrastructure. The methods of operating include generating the acoustic signal with a first acoustic communication node of the plurality of acoustic communication nodes, propagating the acoustic signal through the waveguide, and receiving the propagated acoustic signal as the received acoustic signal with a second acoustic communication node of the plurality of acoustic communication nodes.

### BRIEF DESCRIPTION OF THE DRAWINGS

FIG. 1 is a schematic illustration of examples of a superterranean acoustic communication network according to the present disclosure.

FIG. 2 is a more detailed illustration of examples of a region of the superterranean acoustic communication network of FIG. 1.

FIG. 3 is a flowchart depicting examples of methods of forming a superterranean acoustic communication network, according to the present disclosure.

FIG. 4 is a flowchart depicting examples of methods of operating a superterranean acoustic communication network, according to the present disclosure.

FIG. 5 is a flowchart depicting examples of methods of tuning acoustic communication within a superterranean acoustic communication network, according to the present disclosure.

FIG. 6 is a flowchart depicting examples of methods of tuning acoustic communication within a superterranean acoustic communication network, according to the present disclosure.

### DETAILED DESCRIPTION OF THE INVENTION

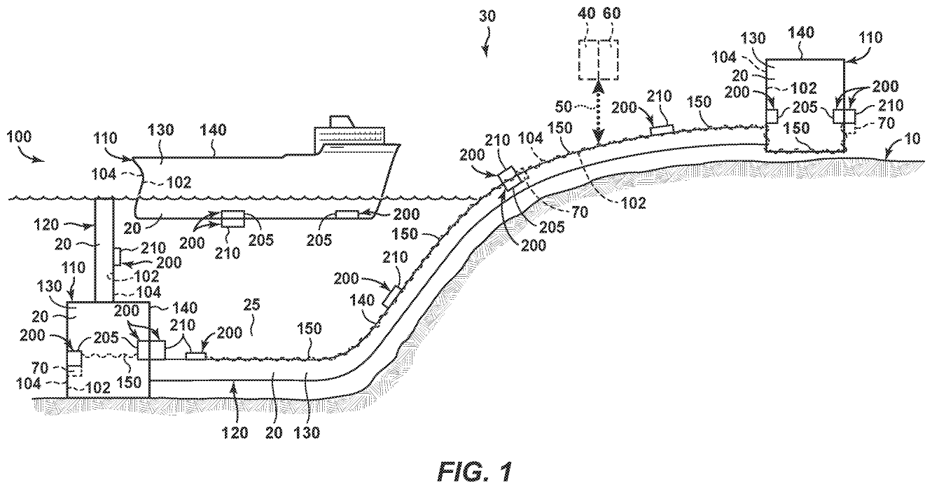

FIGS. 1-6 provide examples of superterranean acoustic communication networks 30, of components of superterranean acoustic communication networks 30, of methods of forming the superterranean acoustic communication networks, of methods of operating the superterranean acoustic communication networks, and/or of methods of tuning acoustic communication within the superterranean acoustic communication networks. Elements that serve a similar, or at least substantially similar, purpose are labeled with like numbers in each of FIGS. 1-6, and these elements may not be discussed in detail herein with reference to each of FIGS. 1-6. Similarly, all elements may not be labeled in each of FIGS. 1-6, but reference numerals associated therewith may be utilized herein for consistency. Elements, components, and/or features that are discussed herein with reference to one or more of FIGS. 1-6 may be included in and/or utilized with any of FIGS. 1-6 without departing from the scope of the present disclosure.

In general, elements that are likely to be included in a particular embodiment are illustrated in solid lines, while elements that are optional are illustrated in dashed lines. However, elements that are shown in solid lines may not be essential to all embodiments and, in some embodiments, may be omitted without departing from the scope of the present disclosure.

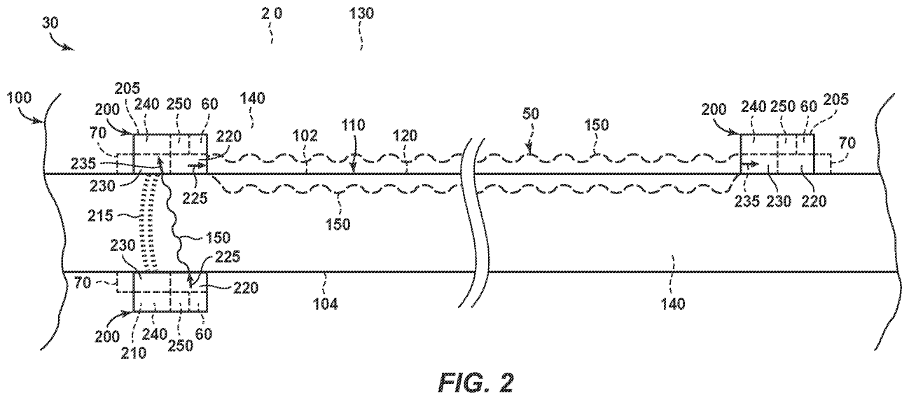

FIG. 1 is a schematic illustration of examples of a superterranean acoustic communication network 30 according to the present disclosure, while FIG. 2 is a more detailed illustration of examples of a region of the superterranean acoustic communication network 30 of FIG. 1. As illustrated in FIGS. 1-2, superterranean acoustic communication networks 30, which also may be referred to herein as superterranean networks 30 and/or as networks 30, include superterranean hydrocarbon infrastructure 100 that may contain a fluid 20, examples of which are disclosed herein. Superterranean hydrocarbon infrastructure 100, which also may be referred to herein as infrastructure 100, defines a waveguide 140 and extends above a ground surface 10, as illustrated in FIG. 1. Superterranean acoustic communication network 30 also includes a plurality of acoustic communication nodes 200. Acoustic communication nodes 200, which also may be referred to herein as nodes 200, may be spaced apart along and/or about infrastructure 100. As illustrated in FIG. 2, each node 200 includes an acoustic transmitter 220 and an acoustic receiver 230.

During operation of networks 30, acoustic transmitter 220 may generate a generated acoustic signal 225 and/or may supply the generated acoustic signal to a waveguide 140, as illustrated by the left-most acoustic communication node 200 that is illustrated in FIG. 2. Responsive to receipt of generated acoustic signal 225, waveguide 140 may convey and/or propagate a propagated acoustic signal 150. Acoustic receivers 230 may receive another propagated acoustic signal 150, which is generated by another acoustic communication node 200 from waveguide 140 as a received acoustic signal 235, as illustrated by the right-most acoustic communication node 200 that is illustrated in FIG. 2.

Acoustic communication nodes 200 may have and/or define any suitable position, relative orientation, and/or spacing on and/or within infrastructure 100. As an example, one or more acoustic communication nodes 200 may include and/or be an internal node 205, which may be internal to and/or mounted on an internal surface 102 of infrastructure 100. As another example, one or more acoustic communication nodes 200 may include and/or be an external node 210, which may be external to and/or mounted on an external surface 104 of infrastructure 100. As yet another example, a spacing, or a distance, between nodes 200 may be selected and/or defined based, at least in part, on one or more properties of waveguide 140, such as an efficiency at which waveguide 140 propagates propagated acoustic signal 150.

Infrastructure 100 may include and/or be any suitable superterranean hydrocarbon infrastructure that may be positioned above ground surface 10, that may contain fluid 20, that may define waveguide 140, that may propagate propagated acoustic signal 150, and/or that may have nodes 200 attached hereto and/or in acoustic communication therewith. In some examples, infrastructure 100 may be formed from and/or defined by an infrastructure material, and the infrastructure material may at least partially define waveguide 140. Stated another way, waveguide 140 may propagate propagated acoustic signal 150 within and/or via the infrastructure material that defines infrastructure 100. Examples of the infrastructure material include a metal, a polymer, and/or a composite. In some examples, fluid 20 that is contained by and/or within infrastructure 100 may at least partially define waveguide 140. Stated another way, the infrastructure material may bound, or at least partially bound, the waveguide.

In some examples, infrastructure 100 may include a hydrocarbon fluid-containing vessel 110, examples of which include a ship, a tanker, a terrestrial tank, and/or a subsea tank. In some such examples, hydrocarbon fluid-containing vessel 110 may be defined by a vessel material, which may at least partially define waveguide 140. Additionally or alternatively, and in some such examples, hydrocarbon fluid-containing vessel 110 may define an enclosed volume 130 that contains fluid 20, and the fluid may at least partially define waveguide 140.

In some examples, infrastructure 100 may include a hydrocarbon fluid-conveying tubular 120, such as a pipe, a pipeline, a fluid transmission line, a process line, and/or a riser. In some such examples, hydrocarbon fluid-conveying tubular 120 may be defined by a tubular material, which may at least partially define waveguide 140. Additionally or alternatively, and in some such examples, hydrocarbon fluid-conveying tubular 120 may define enclosed volume 130 that contains fluid 20, and the fluid may at last partially define waveguide 140. In such examples, enclosed volume 130 also may be referred to herein as a tubular conduit 130.

Acoustic transmitter 220 may include any suitable structure that may be adapted, configured, designed, and/or constructed to generate generated acoustic signal 225 and/or to provide the generated acoustic signal to waveguide 140. In some examples, acoustic transmitter 220 may be configured to generate the generated acoustic signal in the form of an ultrasonic generated acoustic signal. In some examples, generated acoustic signal 225 may have a generated signal frequency of at least 20 kilohertz (kHz). Examples of acoustic transmitter 220 include a vibration generator, an ultrasonic vibration generator, a speaker, and/or an ultrasonic speaker, each of which may be configured to generate the generated acoustic signal.

Acoustic receiver 230 may include any suitable structure that may be adapted, configured, designed, and/or constructed to receive propagated acoustic signal 150, or the other propagated acoustic signal 150, from waveguide 140 as received acoustic signal 235. In some examples, acoustic receiver 230 may be configured to receive the received acoustic signal in the form of an ultrasonic received acoustic signal. In some examples, received acoustic signal 235 may have a received signal frequency of at least 20 kHz. Examples of acoustic receiver 230 include a vibration receiver, an ultrasonic vibration receiver, a microphone, and/or an ultrasonic microphone, each of which may be configured to receive the received acoustic signal.

In some examples, communication nodes 200 may be configured to convey a data signal 50 along infrastructure 100. As an example, nodes 200 may be configured to convey data signal 50 via sequential transfer of a corresponding propagated acoustic signal 150 between adjacent nodes 200. Stated another way, nodes 200 may sequentially transfer propagated acoustic signal 150, which is indicative of data signal 50, therebetween to convey the data signal along, or along a length of, infrastructure 100.

In some examples, at least one acoustic communication node 200 may be configured to adjust, to select, and/or to define at least one property of generated acoustic signal 225 based, at least in part, on at least one acoustic property of waveguide 140, on a change in the at least one acoustic property of the waveguide, and/or on a change in a corresponding received acoustic signal 235 that is received by the at least one acoustic communication node 200. Examples of the at least one property of the generated acoustic signal include a frequency of the generated acoustic signal and/or a waveform of the generated acoustic signal.

In some examples, network 30 may include a network controller 40, as schematically illustrated in FIG. 1. Network controller 40, when present, may be in communication with at least one acoustic communication node 200 and/or may be programmed to control the operation of network 30. As an example, network controller 40 may be programmed to perform, or cause to be performed, any suitable step and/or steps of methods 400, which are discussed in more detail herein. Network controller 40 may include and/or be any suitable structure, device, and/or devices that may be adapted, configured, designed, constructed, and/or programmed to perform, or cause to be performed, the functions discussed herein. As examples, network controller 40 may include one or more of an electronic controller, a dedicated controller, a special-purpose controller, a personal computer, a special-purpose computer, a display device, a logic device, a memory device, and/or a memory device having computer-readable storage media.

In some examples, and as illustrated in FIGS. 1-2, network 30 may include a signal analysis structure 60. Signal analysis structure 60, when present, may form a portion of and/or may be in communication with at least one acoustic communication node 200. Additionally or alternatively, signal analysis structure 60 may form a portion of and/or may be incorporated within network controller 40, when present.

Signal analysis structure 60 may be adapted, configured, designed, and/or programmed to detect an acoustic signal change in at least one property of propagated acoustic signal 150 and to correlate the acoustic signal change to a waveguide change in waveguide 140. Stated another way, the waveguide change in and/or within waveguide 140 may cause propagated acoustic signal 150 to propagate and/or to be modified differently as the propagated acoustic signal propagates in, within, and/or through waveguide 140, thereby producing, generating, and/or causing the acoustic signal change. Stated yet another way, nodes 200 may be referred to herein as and/or may be acoustic communication and sensing nodes 200, which may be configured both for communication along waveguide 140 and for detection of physical phenomena that may occur and/or be present at various locations along the length of the waveguide. With this in mind, signal analysis structure 60 may be configured to detect the acoustic signal change and to determine, correlate, and/or estimate the waveguide change based, at least in part, on the acoustic signal change.

The acoustic signal change may include and/or be any suitable change in a corresponding propagated acoustic signal 150 that is received by a given node 200 as a corresponding received acoustic signal 235. Examples of the acoustic signal change include a change in phase, a change in amplitude, a change in frequency, and/or a change in orientation of the propagated acoustic signal.

The waveguide change may be based upon and/or a result of any suitable change in an environment of and/or within waveguide 140. As examples, the waveguide change may be based upon and/or a result of sand transport within the superterranean hydrocarbon infrastructure, slugging within the superterranean hydrocarbon infrastructure, water hold-up within the superterranean hydrocarbon infrastructure, multi-phase flow within the superterranean hydrocarbon infrastructure, deposition of asphaltenes within the superterranean hydrocarbon infrastructure, build-up of scale within the superterranean hydrocarbon infrastructure, a change in pressure within the superterranean hydrocarbon infrastructure, a change in a flow regime within the superterranean hydrocarbon infrastructure, fatigue of risers within the superterranean hydrocarbon infrastructure, flex in risers within the superterranean hydrocarbon infrastructure, buckling within a component of the superterranean hydrocarbon infrastructure, hull integrity of the superterranean hydrocarbon infrastructure, pipeline integrity of the superterranean hydrocarbon infrastructure, tank integrity of the superterranean hydrocarbon infrastructure, a leak from the superterranean hydrocarbon infrastructure, excavation near the superterranean hydrocarbon infrastructure, corrosion of the superterranean hydrocarbon infrastructure, erosion of the superterranean hydrocarbon infrastructure, a coating thickness of a coating that covers the superterranean hydrocarbon infrastructure, a flow rate of the fluid within the superterranean hydrocarbon infrastructure, a fluid level within the superterranean hydrocarbon infrastructure, a chemical composition of the fluid, a phase of the fluid, a presence and/or appearance of bubbles within the fluid, a presence of solids within the fluid, a gas-hydrate formation within the superterranean hydrocarbon infrastructure, a wax formation within the superterranean hydrocarbon infrastructure, asphaltene onset within the superterranean hydrocarbon infrastructure, and/or asphaltene precipitation within the superterranean hydrocarbon infrastructure

Excavation near the superterranean hydrocarbon infrastructure may include digging near and/or along the superterranean hydrocarbon infrastructure. Stated another way, networks 30 may be sensitive to and/or may detect digging near the superterranean hydrocarbon infrastructure, such as via detection of noise and/or vibration, and/or may be utilized to specify and/or to identify both occurrence of the digging and a location of the digging.

Vibration of superterranean hydrocarbon infrastructure 100 may be caused by a variety of factors. When a section of a long pipeline starts to vibrate, which may be caused by river flooding and known as vertex induced vibration (VIV), localized pipeline damage may occur. Localized pipeline failures may also be due to vibration from an operating pump. Subsea drilling string can be damaged from localized vibration too. This type of vibration is normally less than 100 Hz, and if the amplitudes of these types of vibrations are large, such as due to resonance, pipeline failure may occur. It historically has been quite difficult to pinpoint the exact location of the vibration when the pipeline is long. It is thus desirable to detect the location and the magnitude of the localized vibration at an early stage to prevent pipeline material failure and loss of containment. Networks 30 may permit and/or facilitate such detection.

The waveguide change additionally or alternatively may be based upon and/or a result of any suitable change in a property of waveguide 140. As examples, the waveguide change may be based upon and/or a result of strain within a component of the superterranean hydrocarbon infrastructure, stress within a component of the superterranean hydrocarbon infrastructure, a pressure change within the superterranean hydrocarbon infrastructure, and/or a temperature of the superterranean hydrocarbon infrastructure.

As discussed, networks 30 may detect waveguide changes in waveguide 140 and/or may correlate these waveguide changes to physical phenomena that may occur and/or be present along the length of the waveguide. With this in mind, networks 30, according to the present disclosure, also may be referred to herein as distributed networks 30 and/or as distributed sensing networks 30. Stated another way, networks 30 may function as distributed sensors and/or may be configured to detect both the waveguide changes and locations, along the length of the waveguide, for the waveguide changes. This may permit and/or facilitate improved detection of, quantification of, and/or response to the physical phenomena that produce the waveguide changes.

In some examples, network 30 may include one or more sensors 70. Sensors 70, when present, may be adapted, configured, designed, and/or constructed to detect at least one property of infrastructure 100. Each sensor 70 may be in communication with, may be associated with, and/or may form a portion of at least one node 200. In such a configuration, network 30 may be configured to generate and/or to propagate propagated acoustic signal 150, which is indicative of the at least one property of infrastructure 100. Stated another way, sensor 70 may be configured to detect the at least one property of infrastructure 100 and to convey information regarding the at least one property of infrastructure 100 to one or more nodes 200. Nodes 200 then may convey the information regarding the at least one property of infrastructure 100 along infrastructure 100.

In some examples, sensor 70 may include and/or be an acoustic sensor. In some such examples, the acoustic sensor may be configured to determine the at least one property of the superterranean hydrocarbon infrastructure based, at least in part, on the propagated acoustic signal. Additionally or alternatively, and in some such examples, the acoustic sensor may be configured to generate a sensor acoustic signal, which differs from the propagated acoustic signal, and to determine the at least one property of the superterranean hydrocarbon infrastructure based, at least in part, on the sensor acoustic signal.

In some examples, the sensor may not be an acoustic sensor. In some such examples, the sensor may include and/or be any suitable conventional sensor, examples of which include a thermocouple, a strain gauge, a pressure gauge, and/or an accelerometer.

Regardless of the exact configuration of sensors 70, the sensors may be configured to detect any suitable property of infrastructure 100. Examples of the property of infrastructure 100 include strain within a component of the superterranean hydrocarbon infrastructure, stress within a component of the superterranean hydrocarbon infrastructure, a pressure change within the superterranean hydrocarbon infrastructure, a temperature of the superterranean hydrocarbon infrastructure, a flow rate of the fluid within the superterranean hydrocarbon infrastructure, a fluid level within the superterranean hydrocarbon infrastructure, a chemical composition of the fluid, and/or a phase of the fluid.

Acoustic communication nodes 200 may include any suitable structure that includes acoustic transmitter 220 and/or acoustic receiver 230 and/or that may be adapted, configured, designed, and/or constructed to generate generated acoustic signal 225 and/or to receive propagated acoustic signal 150 as received acoustic signal 235. In some examples, nodes 200 may include a node controller 240. Node controller 240, when present, may be adapted, configured, designed, and/or constructed to direct acoustic transmitter 220 to generate generated acoustic signal 225 and/or to receive received acoustic signal 235, or data indicative of the received acoustic signal, from the acoustic receiver 230. Additionally or alternatively, node controller 240 may be adapted configured, designed, and/or constructed to adjust, to select, and/or to define the at least one property of generated acoustic signal 225 based, at least in part, on the at least one acoustic property of waveguide 140, as discussed herein.

In some examples, nodes 200 may include a node power source 250. Node power source 250, when present, may be adapted, configured, designed, and/or constructed to electrically power at least one other component of nodes 200, such as acoustic transmitter 220 and/or acoustic receiver 230. Examples of node power source 250 include an electrical energy storage device, a rechargeable electrical energy storage device, and/or an energy harvesting device. More specific examples of node power source 250 include a battery, a rechargeable battery, a capacitor, and/or an inductor.

In some configurations, network 30 may be configured to convey propagated acoustic signal 150 through a wall of infrastructure 100, such as to permit and/or facilitate communication between one or more internal nodes 205 and one or more external nodes 210. In such a configuration, network 30 also may be referred to herein as being utilized to produce and/or generate acoustically transparent superterranean hydrocarbon infrastructure.

In some such examples, and as discussed, infrastructure 100 may define enclosed volume 130 that may contain fluid 20. In such a configuration, internal node 205 may be positioned within enclosed volume 130, such as on internal surface 102 of infrastructure 100, and external node 210 may be positioned external to enclosed volume 130, such as on external surface 104 of infrastructure 100. Also in such a configuration, internal node 205 may be in acoustic communication with external node 210 via waveguide 140 that is defined by the infrastructure material that defines infrastructure 100 and/or through a wall of infrastructure 100 that at least partially defines enclosed volume 130. Stated another way, internal node 205 may be in communication with external node 210 without, or without the need for, a hole and/or aperture within infrastructure 100 and/or without, or without the need for, a cable that extends between the internal node and the external node. Such a configuration may permit and/or facilitate monitoring of internal conditions, within infrastructure 100, without, or without the need for, the hole and/or aperture, which could present a potential leakage path from enclosed volume 130 and/or could compromise a mechanical integrity of infrastructure 100.

In some such examples, and as perhaps best illustrated in FIG. 2, external node 210 may be configured to provide a power signal 215 to internal node 205. In such a configuration, internal node 205 may be configured to receive power signal 215 and/or to be at least partially powered by the power signal. Such a configuration may permit and/or facilitate powering and/or charging of internal node 205 without the need for a power cable that connects to the internal node. Stated another way, network 30 may not include, or may be free of, an electric power connection to internal node 205. Examples of power signal 215 include an acoustic power signal and/or an inductive power signal.

In some configurations, infrastructure 100 may include hydrocarbon fluid-conveying tubular 120, such as the hydrocarbon pipeline, that may be configured to convey fluid 20. In such a configuration, nodes 200 may be spaced apart along a length of the hydrocarbon pipeline and/or may be configured to propagate, or to convey, propagated acoustic signal 150 along the length of the hydrocarbon pipeline. Such a configuration may permit and/or facilitate communication between one region of infrastructure 100 and another region of the infrastructure. In some such examples, the hydrocarbon pipeline itself may define waveguide 140. In some such examples, the hydrocarbon pipeline may contain the waveguide, such as when the waveguide is defined by fluid 20 that extends within the hydrocarbon pipeline.

Fluid 20 may include and/or be any suitable fluid that may be contained within and/or conveyed by infrastructure 100. Examples of fluid 20 include hydrocarbon fluid, oil, crude oil, refined oil, natural gas, liquefied natural gas, a hydrocarbon fuel, carbon dioxide, and/or water. In some examples, one or more other fluids also may be contained within and/or conveyed by infrastructure 100. Examples of these other fluids include water, water vapor, air, nitrogen, and/or carbon dioxide.

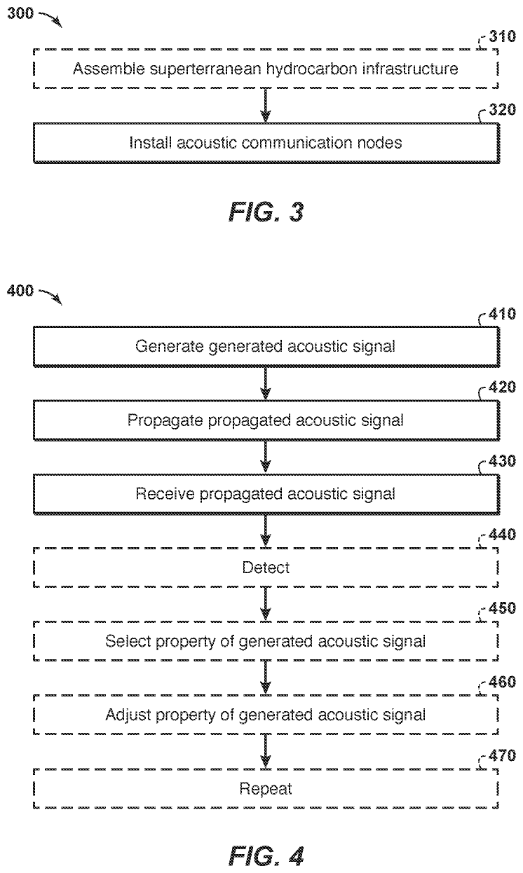

FIG. 3 is a flowchart depicting examples of methods 300 of forming a superterranean acoustic communication network, according to the present disclosure, such as network 30 of FIGS. 1-2. Methods 300 may include assembling superterranean hydrocarbon infrastructure at 310 and include installing acoustic communication nodes at 320, such as node 200 of FIGS. 1-2.

The assembling at 310 may include assembling any suitable superterranean hydrocarbon infrastructure in any suitable manner. As an example, the assembling at 310 may include constructing and/or erecting a hydrocarbon fluid-containing vessel, such as hydrocarbon fluid-containing vessels 110 of FIG. 1. As another example, the assembling at 310 may include constructing and/or erecting a hydrocarbon fluid-conveying tubular, such as hydrocarbon fluid-conveying tubular 120 of FIG. 1.

The installing at 320 may include installing a plurality of acoustic communication nodes on and/or within the superterranean hydrocarbon infrastructure. In some examples, the superterranean hydrocarbon infrastructure may include and/or be existing, or previously assembled, superterranean hydrocarbon infrastructure. In some such examples, the installing at 320 may include installing the plurality of acoustic communication nodes on an external surface of the existing superterranean hydrocarbon infrastructure and/or retrofitting the existing superterranean hydrocarbon infrastructure with the plurality of acoustic communication nodes, such as to form and/or define the superterranean acoustic communication network.

In some examples, such as when methods 300 include the assembling at 310, the installing at 320 may be performed at least partially concurrently with the assembling at 310. In some such examples, at least one acoustic communication node of the plurality of acoustic communication nodes may include and/or be an internal node that is internal to the superterranean hydrocarbon infrastructure, that is positioned on an internal surface of the superterranean hydrocarbon infrastructure, and/or that is positioned within an enclosed volume that may be at least partially defined and/or bounded by the superterranean hydrocarbon infrastructure. In some such examples, the installing at 320 additionally or alternatively may include installing such that the superterranean hydrocarbon infrastructure is free of a communication cable and/or a power cable that extends from the internal node to external the superterranean hydrocarbon infrastructure.

FIG. 4 is a flowchart depicting examples of methods 400 of operating a superterranean acoustic communication network, according to the present disclosure, such as superterranean acoustic communication network 30 of FIGS. 1-2. Methods 400 include generating a generated acoustic signal at 410, propagating a propagated acoustic signal at 420, and receiving the propagated acoustic signal at 430. Methods 400 also may include detecting 440, selecting a property of the generated acoustic signal at 450, adjusting the property of the generated acoustic signal at 460, and/or repeating at least a subset of the methods at 470.

Generating the generated acoustic signal at 410 may include generating the generated acoustic signal with a first acoustic communication node of a plurality of acoustic communication nodes. Additionally or alternatively, the generating at 410 may include providing the generated acoustic signal to a waveguide that is defined by the superterranean hydrocarbon infrastructure and/or inducing the propagated acoustic signal within the waveguide. The generating at 410 may be performed utilizing any suitable structure of the first acoustic communication node, such as by an acoustic transmitter of the first acoustic communication node. Examples of the acoustic transmitter are disclosed herein with reference to acoustic transmitter 220.

Propagating the propagated acoustic signal at 420 may include propagating the propagated acoustic signal through the waveguide. As discussed, the propagated acoustic signal may be induced and/or initiated responsive to receipt of the generated acoustic signal by the waveguide. As such, the propagating at 420 may be referred to herein as being responsive to and/or a result of the generating at 410. In some examples, and as discussed, the propagating at 420 may include propagating the propagated acoustic signal within an infrastructure material that defines the superterranean hydrocarbon infrastructure. In some examples, and as also discussed, the propagating at 420 may include propagating the propagated acoustic signal within a fluid that is contained within the superterranean hydrocarbon infrastructure.

Receiving the propagated acoustic signal at 430 may include receiving the propagated acoustic signal with a second acoustic communication node of the plurality of acoustic communication nodes. This may include receiving the propagated acoustic signal as a received acoustic signal that is received by the second acoustic communication node. The receiving at 430 may be performed utilizing any suitable structure of the second acoustic communication node, such as by an acoustic receiver of the second acoustic communication node. Examples of the acoustic receiver are disclosed herein with reference to acoustic receiver 230.

In some examples, the detecting at 440 may include detecting an acoustic signal change. The acoustic signal change may include and/or be any suitable change in at least one property of the propagated acoustic signal. In some such examples, the detecting at 440 further may include correlating the acoustic signal change to a waveguide change of the waveguide. Examples of the acoustic signal change and/or of the waveguide change are disclosed herein.

In some examples, the detecting at 440 may include detecting at least one property of the superterranean hydrocarbon infrastructure with, via, and/or utilizing a sensor. Examples of the sensor are disclosed herein. In some such examples, the generating at 410 may include generating the generated acoustic signal based, at least in part, on the at least one property of the superterranean hydrocarbon infrastructure. Stated another way, and when methods 400 include detecting the at least one property of the superterranean hydrocarbon infrastructure, methods 400 further may include conveying information regarding the at least one property of the superterranean hydrocarbon infrastructure along the infrastructure and/or via the propagated acoustic signal.

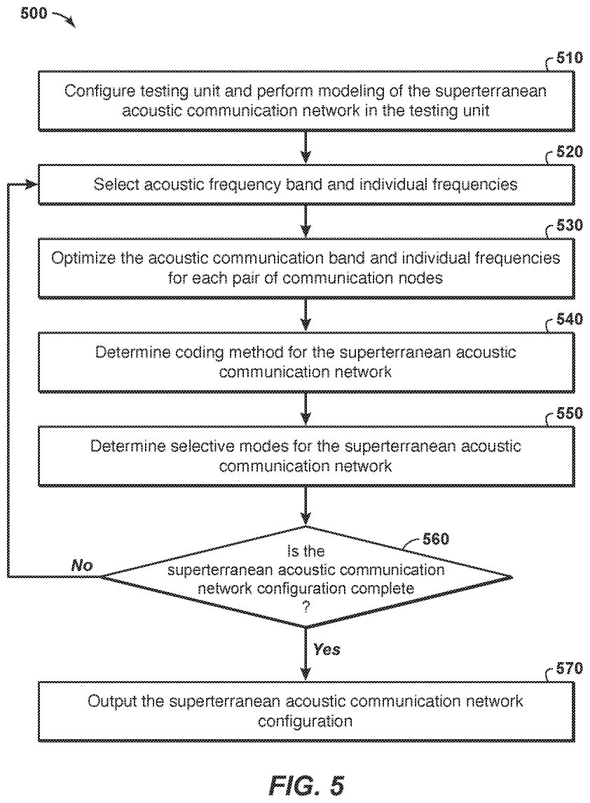

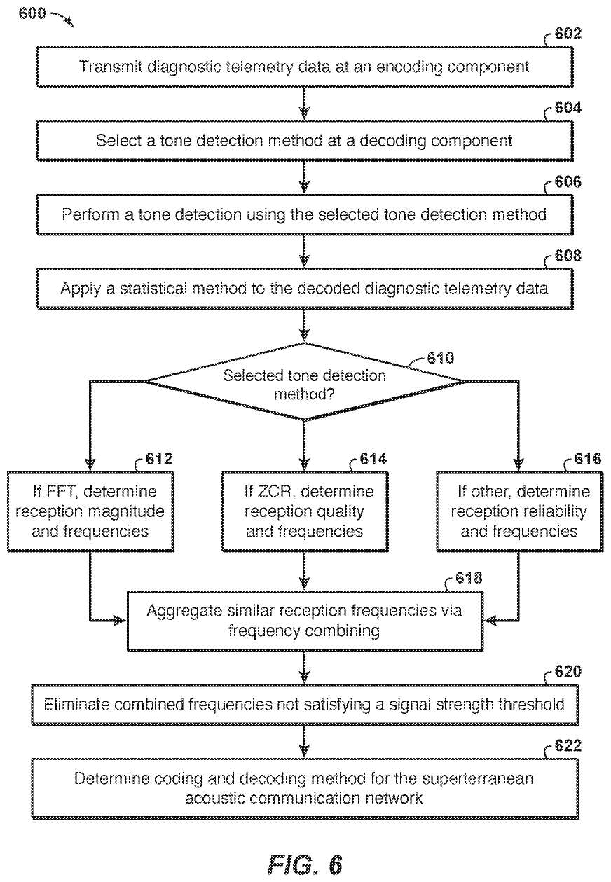

In some examples, methods 400 may be configured to improve, to increase a signal-to-noise ratio of, and/or to optimize communication among the plurality of acoustic communication nodes. In some such examples, methods 400 further may include the selecting at 450 and/or the adjusting at 460. In some such examples, this improvement in, increase in signal-to-noise ratio of, and/or optimization of communication among the plurality of acoustic communication nodes may be referred to as tuning acoustic communication within the superterranean acoustic communication network and/or may be realized at least partially utilizing methods 500 of FIG. 5 and/or methods 600 of FIG. 6, which are discussed in more detail herein. Additional examples of methods of improving, increasing a signal-to-noise ratio of, and/or optimizing communication among the plurality of acoustic communication nodes are disclosed in U.S. Pat. No. 10,771,326, which was filed on Sep. 24, 2018, and the complete disclosure of which is hereby incorporated by reference.

Selecting the property of the generated acoustic signal at 450 may include selecting at least one property of the generated acoustic signal based, at least in part, on at least one acoustic property of the waveguide. As an example, methods 400 may be configured to analyze the received acoustic signal and/or to compare the generated acoustic signal to the received acoustic signal to determine and/or establish the at least one acoustic property of the waveguide. Methods 400 then may be configured to modify the generated acoustic signal based, at least in part, on the at least one acoustic property of the waveguide, such so to improve communication between adjacent acoustic communication nodes. As another example, methods 400 may be configured to provide a plurality of different generated acoustic signals to the waveguide and to select a given generated acoustic signal of the plurality of different generated acoustic signals for communication between corresponding acoustic communication nodes based, at least in part, on the given generated acoustic signal providing better acoustic communication when compared to other generated acoustic signals of the plurality of different generated acoustic signals.

Adjusting the property of the generated acoustic signal at 460 may include adjusting the at least one property of the generated acoustic signal based, at least in part, on a change in the at least one property of the waveguide. As an example, and during methods 400, the waveguide may change and/or be modified, such as via a change in a structure of the waveguide and/or a change in an acoustic environment of the waveguide. The change in the at least one property of the waveguide may decrease the signal-to-noise ratio for communication between two or more communication nodes. However, the adjusting at 460 may be utilized to improve and/or to restore the communication. Stated another way, methods 400 periodically may evaluate the waveguide, such as by performing the detecting at 440, the selecting at 450, and/or the adjusting at 460, to determine whether the generated acoustic signal may be modified to improve communication among the acoustic communication nodes. If such an improvement is available, methods 400 may include adjusting the generated acoustic signal to produce and/or realize the improvement in communication among the acoustic communication nodes.

Repeating at least the subset of the methods at 470 may include repeating any suitable step and/or steps of methods 400 in any suitable manner and/or for any suitable purpose. As an example, the repeating at 470 may include sequentially repeating at least the generating at 410, the propagating at 420, and the receiving at 430 between adjacent acoustic communication nodes of the plurality of acoustic communication nodes, such as to transmit a data signal along a length of the superterranean hydrocarbon infrastructure. As another example, the repeating at 470 may include periodically, or intermittently, repeating at least the generating at 410, the propagating at 420, and the receiving at 430 to transfer a plurality of corresponding data signals between the first acoustic communication node and the second acoustic communication node and/or along the length of the length of the superterranean hydrocarbon infrastructure.

FIG. 5 is a flowchart depicting examples of methods 500 of tuning acoustic communication within a superterranean acoustic communication network, according to the present disclosure. Methods 500 may include performing various steps, such as steps 510 to 550. Subsequently, a determination may be made as to whether communication within the superterranean acoustic communication network is sufficiently tuned, and the communication network configuration may be outputted, as shown in steps 560 and 570.

To begin, methods 500 involve performing various steps, as shown in steps 510 to 550. At step 510, a testing unit may be configured such that the testing unit may be utilized to model the superterranean acoustic communication network in the testing unit. Configuration of the testing unit may include installing and configuring acoustic communication nodes or comparable physical and/or electrical representations of the acoustic communication nodes of the superterranean acoustic communication network in the testing unit. The testing unit may include a housing that has one or more tubular members and the associated acoustic communication nodes, which may be distributed along and coupled to the tubular members, may be disposed within the housing of the testing unit. The testing unit also may contain a fluid disposed within and/or around the tubular member within the housing. The tubular members in the testing unit may be filled with water, air or any combination thereof so to preselect an acoustic communication frequency band or individual frequencies for later use during communication within the superterranean acoustic communication network. In some examples, the testing unit may include dampening devices that may be configured to model or represent additional distances on the tubular members, such as may be representative of the distance between adjacent acoustic communication nodes within the superterranean acoustic communication network.

At step 520, the acoustic frequency band and individual frequencies for communication may be selected (e.g., the acoustic frequency band and individual frequencies of the generated acoustic signal, the propagated acoustic signal, and/or the received acoustic signal). The acoustic frequency band and individual frequencies may include each frequency in the plurality of high-frequency ranges, which may be at least 20 kilohertz (kHz), at least 25 kHz, at least 50 kHz, at least 60 kHz, at least 70 kHz, at least 80 kHz, at least 90 kHz, at least 100 kHz, at least 200 kHz, at least 250 kHz, at least 400 kHz, at least 500 kHz, and/or at least 600 kHz. Additionally or alternatively, each frequency in the plurality of high frequency ranges may be at most 1,000 kHz (1 megahertz (MHz)), at most 800 kHz, at most 750 kHz, at most 600 kHz, at most 500 kHz, at most 400 kHz, at most 200 kHz, at most 150 kHz, at most 100 kHz, and/or at most 80 kHz. Further, each frequency in the low-frequency ranges may be at least 20 hertz (Hz), at least 50 Hz, at least 100 Hz, at least 150 Hz, at least 200 Hz, at least 500 Hz, at least 1 kHz, at least 2 kHz, at least 3 kHz, at least 4 kHz, and/or at least 5 kHz. Additionally or alternatively, each frequency in the high frequency ranges may be at most 10 kHz, at most 12 kHz, at most 14 kHz, at most 15 kHz, at most 16 kHz, at most 17 kHz, at most 18 kHz, and/or at most 20 kHz.

Then, at step 530, the acoustic communication band and individual frequencies for each pair of communication nodes may be optimized. The optimization may include determining explicit multiple frequency shift keying (MFSK) frequencies.

At step 540, the coding methods for the superterranean acoustic communication network may be determined. The coding method may include an encoding method and decoding method, which may be different from each other.

Within the frequency band, clock ticks may be optimized to maximize data communication rate. For example, the coding method may be selected based on availability of frequency bands and/or communication rates may be compromised if the frequency band is limited. In certain configurations, the coding method may include performing frequency combining based on one or more clock ticks per tone (e.g., one clock tick per tone, two clock ticks per tone, three clock ticks per tone, and/or more clock ticks per tone) to achieve more or fewer tones within a frequency band. The frequency combining may involve using fewer clock ticks per tone to provide more tones with improved signal strength suitable for use with MFSK, which provides more digital bits conveyed per tone and/or which result in faster and more efficient communication (communicate more bits using fewer tones per packet with a corresponding energy savings). The minimum configuration may include one clock tick per tone. In other configurations, the frequency combining may involve using more clock ticks per tone to move the tones farther apart in frequency to compensate for poor acoustic propagation, excessive background noise, and similar issues within the testing unit and/or within the superterranean acoustic communication network. However, this also may result in fewer strong tones being available for use with MFSK, which may cause slower communication and more tones per packet with a corresponding energy cost. With a sufficiently wide frequency band, enough strong tones may be used to compensate for using multiple clock ticks per tone.

At step 550, selective modes for the superterranean acoustic communication network may be determined. At step 560, a determination may be made regarding whether the superterranean acoustic communication network configuration is complete. The determination may include verifying operation of the acoustic communication nodes in the superterranean acoustic communication network.

If the superterranean acoustic communication network configuration is not complete, various steps may be repeated. As shown in the flowchart for methods 500, the selection of acoustic frequency band and individual frequencies may be performed, as shown by step 520. If the superterranean acoustic communication network configuration is complete, the network configuration may be outputted, as shown in step 570. The outputting of the network configuration may include storing the network configuration and/or displaying the network configuration.

As may be appreciated, the acoustic communication nodes may be configured with a setting or profile. The settings may include various parameters, such those of steps 520, 530 and/or 540. The settings may include acoustic frequency band and individual frequencies (e.g., acoustic communication band and individual frequencies for each pair of acoustic communication nodes); and/or coding methods (e.g., establishing how many tones to use for MFSK (2, 4, 8, etc.) and/or whether to use direct mapping or spread spectrum), and/or a tone detection method, such as FFT, ZCX and other methods. The settings may include frequency combining using one or more clock ticks per tone. The tones may be selected to compensate for poor acoustic propagation within the superterranean acoustic communication network.

FIG. 6 is a flowchart depicting examples of additional methods 600 of tuning acoustic communication within a superterranean acoustic communication network, according to the present disclosure. More specifically, methods 600 represent methods of performing an acoustic communication band optimization, while selecting a tone detection method. The optimization may be a manual or an automated activity that may occur, by way of example, during the installation of the superterranean acoustic communication network, at the beginning of network activity of the superterranean acoustic communication network, in response to an event experienced by the superterranean acoustic communication network, and/or in response to one or more other triggering conditions. Methods 600 may include performing an acoustic communication band optimization, as shown in steps 602 to 608. Then, a tone detection may be selected, as shown in steps 610 to 622.

To begin, the acoustic communication band optimization may be determined, as shown in steps 602 to 608. At step 602, diagnostic telemetry data may be transmitted at an encoding component. Then, at step 604, a tone detection method may be selected at a decoding component. At step 606, tone detection using the selected tone detection method may be performed. At step 608, a statistical method to the decoded diagnostic telemetry data may be applied.

Then, a tone detection may be selected, as shown in steps 610 to 622. At step 610, a determination may be made for a tone detection method. The method for acoustic communication band optimization may be dependent on the selected tone detection method. If the selected tone detection method is fast Fourier transform (FFT), the reception magnitude and frequencies may be determined, as shown in 612. The determination may include identifying reception frequencies and the FFT magnitude for each reception frequency. If the selected tone detection method is zero crossing (ZCX), the reception quality and frequencies may be determined in step 614. The determination may include identifying reception frequencies and the ZCX quality of each reception frequency. If the selected tone detection method is not FFT and not ZCX, the reception reliability and frequencies may be determined in step 616. The determination may include identifying reception frequencies and the reliability of each reception frequency as assessed using a data analysis method judged suitable by a person skilled in the art.

Further, in steps 618 to 622, the frequencies may be adjusted. At step 618, similar reception frequencies may be aggregated via frequency combining. The aggregation may involve combining similar reception frequencies by using frequency combining. The frequency combining may include dividing the range of possible reception frequencies into a number of sections and classifies all reception frequencies within any one band as occurrences of a single frequency. It may be apparent to a person skilled in the computational arts that the totality of possible reception frequencies may be excessively large, which may lead to an excessive degree of computational complexity inherent in analysis of the reception frequencies, and that frequency combining may limit the number of possibilities to reduce the computational complexity inherent in analysis of the possibilities to an acceptable level.

Then, at step 620, the combined frequencies not satisfying (e.g., that fail to meet) a signal strength threshold may be eliminated. Signal strength may be determined based on FFT magnitude, ZCX quality, reception reliability, some other characteristic, and/or any combination thereof. The threshold may be based on a particular value or may be determined to eliminate a particular proportion of the combined frequencies. The combined frequencies not eliminated may represent the optimized acoustic communication band.

At step 622, the coding and decoding method for the superterranean acoustic communication network may be determined. The determination may be based on the combined frequencies not eliminated. Examples of coding and decoding methods on the tones from the subset include direct mapping method and spread spectrum methods. As an example, using an extremely weak acoustic channel, a single tone may be used in a direct mapping method for a communication band that includes a single frequency. As another example, using an extremely strong acoustic channel, a predetermined number of tones having optimal signal strength may be organized as an optimal arrangement of either spread spectrum or direct mapping, selected based on an optimal combination of high rate of communication, a low error rate, and/or low power consumption. This step may include use of diagnostic telemetry data.

By way of example, certain types of MFSK involve a certain number of tones, which may be in the powers of two: two, four, eight, sixteen, and continuing further. The comparison may involve ranking the strength of the tones and choosing a number of tones to provide the largest-possible power of two. In particular, if there are nineteen candidate tones, the comparison may involve maintaining the strongest sixteen candidate tone. Accordingly, using the MFSK using sixteen tones is equivalent to sending four digital bits per tone.

The results of the flowchart may be stored in the respective acoustic communication nodes as a setting. The superterranean acoustic communication network configuration may include settings for an acoustic communication band optimization method and/or for selection of a tone detection method. Each of the acoustic communication nodes may include a specific setting or configuration, which may be configured for each adjacent pair of acoustic communication nodes within the superterranean acoustic communication network. As such, methods 600 may be utilized to optimize communication among the acoustic communication nodes, such as by providing optimal acoustic bands to be utilized for communication (via the generated acoustic signal) and/or providing optimal detection methodologies for detection of the propagated acoustic signal as the received acoustic signal.

In the present disclosure, several of the illustrative, non-exclusive examples have been discussed and/or presented in the context of flow diagrams, or flowcharts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that any of the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

### INDUSTRIAL APPLICABILITY

The systems and methods disclosed herein are applicable to the oil and gas industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

What is claimed:

1. A superterranean acoustic communication network for hydrocarbon infrastructure that contains a fluid, the network comprising:
superterranean hydrocarbon infrastructure that extends above a ground surface and defines a waveguide; and
a plurality of acoustic communication nodes spaced-apart along the superterranean hydrocarbon infrastructure, wherein each acoustic communication node of the plurality of acoustic communication nodes includes:
(i) an acoustic transmitter configured to generate a generated acoustic signal and to supply the generated acoustic signal to the waveguide, wherein, responsive to receipt of the generated acoustic signal, the waveguide is configured to propagate a propagated acoustic signal there through; and
(ii) an acoustic receiver configured to receive another propagated acoustic signal, which is generated by another acoustic communication node of the plurality of acoustic communication nodes, from the waveguide as a received acoustic signal.

2. The superterranean acoustic communication network of claim 1, wherein the superterranean hydrocarbon infrastructure is defined by an infrastructure material, and further wherein the infrastructure material at least partially defines the waveguide.

3. The superterranean acoustic communication network of claim 2, wherein the infrastructure material includes at least one of a metal, a polymer, and a composite.

4. The superterranean acoustic communication network of claim 1, wherein the superterranean hydrocarbon infrastructure contains the fluid.

5. The superterranean acoustic communication network of claim 4, wherein the fluid at least partially defines the waveguide.

6. The superterranean acoustic communication network of claim 1, wherein the superterranean hydrocarbon infrastructure includes a hydrocarbon fluid-containing vessel.

7. The superterranean acoustic communication network of claim 6, wherein the hydrocarbon fluid-containing vessel is defined by a vessel material, and further wherein the vessel material at least partially defines the waveguide.

8. The superterranean acoustic communication network of claim 6, wherein the hydrocarbon fluid-containing vessel defines an enclosed volume that contains the fluid, and further wherein the fluid at least partially defines the waveguide.

9. The superterranean acoustic communication network of claim 1, wherein the superterranean hydrocarbon infrastructure includes a hydrocarbon fluid-conveying tubular.

10. The superterranean acoustic communication network of claim 9, wherein the hydrocarbon fluid-conveying tubular is defined by a tubular material, and further wherein the tubular material at least partially defines the waveguide.

11. The superterranean acoustic communication network of claim 9, wherein the hydrocarbon fluid-conveying tubular defines a tubular conduit that contains the fluid, and further wherein the fluid at least partially defines the waveguide.

12. The superterranean acoustic communication network of claim 1, wherein the acoustic transmitter is configured to generate the generated acoustic signal in the form of an ultrasonic generated acoustic signal.

13. The superterranean acoustic communication network of claim 1, wherein the acoustic transmitter includes a vibration generator configured to generate the generated acoustic signal.

14. The superterranean acoustic communication network of claim 1, wherein the generated acoustic signal has a generated signal frequency of at least 20 kilohertz (kHz).

15. The superterranean acoustic communication network of claim 1, wherein the acoustic receiver is configured to receive the received acoustic signal in the form of an ultrasonic received acoustic signal.

16. The superterranean acoustic communication network of claim 1, wherein the acoustic receiver includes a vibration receiver configured to receive the received acoustic signal.

17. The superterranean acoustic communication network of claim 1, wherein the received acoustic signal has a received signal frequency of at least 20 kHz.

18. The superterranean acoustic communication network of claim 1, wherein the plurality of acoustic communication nodes is configured to convey a data signal along the superterranean hydrocarbon infrastructure via sequential transfer of a corresponding propagated acoustic signal between adjacent acoustic communication nodes of the plurality of acoustic communication nodes.

19. The superterranean acoustic communication network of claim 1, wherein the acoustic transmitter of at least one acoustic communication node of the plurality of acoustic communication nodes is configured to select at least one property of the generated acoustic signal based, at least in part, on at least one acoustic property of the waveguide.

20. The superterranean acoustic communication network of claim 19, wherein the at least one property of the generated acoustic signal includes at least one of:
(i) a frequency of the generated acoustic signal; and
(ii) a waveform of the generated acoustic signal.

21. The superterranean acoustic communication network of claim 19, wherein the at least one acoustic communication node further is configured to adjust the at least one property of the generated acoustic signal based, at least in part, on a change in the at least one acoustic property of the waveguide.

22. The superterranean acoustic communication network of claim 1, wherein the superterranean acoustic communication network further includes a network controller programmed to control the operation of the superterranean acoustic communication network, wherein the network controller is in communication with at least one acoustic communication node of the plurality of acoustic communication nodes.

23. The superterranean acoustic communication network of claim 1, wherein the superterranean acoustic communication network further includes a signal analysis structure in communication with at least one acoustic communication node of the plurality of acoustic communication nodes, wherein the signal analysis structure is configured to detect an acoustic signal change in at least one property of the propagated acoustic signal and to correlate the acoustic signal change to a waveguide change of the waveguide.

24. The superterranean acoustic communication network of claim 23, wherein the waveguide change of the waveguide includes at least one of:
(i) sand transport within the superterranean hydrocarbon infrastructure;
(ii) slugging within the superterranean hydrocarbon infrastructure;
(iii) water hold-up within the superterranean hydrocarbon infrastructure;
(iv) multi-phase flow within the superterranean hydrocarbon infrastructure;
(v) deposition of asphaltenes within the superterranean hydrocarbon infrastructure;
(vi) build-up of scale within the superterranean hydrocarbon infrastructure;
(vii) fatigue of risers within the superterranean hydrocarbon infrastructure;
(viii) flex in risers within the superterranean hydrocarbon infrastructure;
(ix) buckling within a component of the superterranean hydrocarbon infrastructure;
(x) hull integrity of the superterranean hydrocarbon infrastructure;
(xi) pipeline integrity of the superterranean hydrocarbon infrastructure;
(xii) tank integrity of the superterranean hydrocarbon infrastructure;
(xiii) a leak from the superterranean hydrocarbon infrastructure;
(xiv) excavation near the superterranean hydrocarbon infrastructure;
(xv) corrosion of the superterranean hydrocarbon infrastructure;
(xvi) erosion of the superterranean hydrocarbon infrastructure;
(xvii) a coating thickness of a coating that covers the superterranean hydrocarbon infrastructure;
(xviii) a gas-hydrate formation within the superterranean hydrocarbon infrastructure;
(xix) a wax formation within the superterranean hydrocarbon infrastructure;
(xx) asphaltene onset within the superterranean hydrocarbon infrastructure;
(xxi) asphaltene precipitation within the superterranean hydrocarbon infrastructure;
(xxii) a presence of bubbles within the fluid; and
(xxiii) a presence of solids within the fluid.

25. The superterranean acoustic communication network of claim 23, wherein the waveguide change of the waveguide includes at least one of:
(i) strain within a component of the superterranean hydrocarbon infrastructure;
(ii) stress within a component of the superterranean hydrocarbon infrastructure;
(iii) a pressure change within the superterranean hydrocarbon infrastructure;
(iv) a temperature of the superterranean hydrocarbon infrastructure;
(v) a flow rate of the fluid within the superterranean hydrocarbon infrastructure;
(vi) a fluid level within the superterranean hydrocarbon infrastructure;
(vii) a chemical composition of the fluid; and
(viii) a phase of the fluid.
